(19) United States
(12) Patent Application Publication
(10) Pub. No.: US 2023/0380626 A1
(43) Pub. Date: Nov. 30, 2023

(54) MODULAR BAKE TRAY ASSEMBLY WITH REMOVABLE PANINI PRESS

(71) Applicant: SharkNinja Operating LLC, Needham, MA (US)

(72) Inventors: Nathaniel R. Lavins, Cambridge, MA (US); Paul Clark Thomas, Wellesley, MA (US)

(21) Appl. No.: 18/069,627

(22) Filed: Dec. 21, 2022

Related U.S. Application Data
(60) Provisional application No. 63/265,906, filed on Dec. 22, 2021.

(51) Int. Cl. A47J 37/06; A21B 3/13; A47J 37/01

(52) U.S. Cl. CPC A47J 37/0611; A21B 3/131; A47J 37/01; A21B 3/135; A47J 37/0664

(57) ABSTRACT

A cooking device assembly is provided. The cooking device assembly includes a cooking device having a housing with an opening and a cooking compartment arranged therein. A tray assembly is configured to be arranged within the cooking compartment, and includes a tray having a first cooking surface, a shield configured to sustainably cover the opening of the housing when the tray assembly is inserted into the cooking compartment, and an accessory removably mated to the tray, having a grill plate and a bracket. The grill plate has a second cooking surface. The bracket has a first arm pivotally connected to a first side of the grill plate, and a second arm pivotally connected to a second side of the grill plate. The first cooking surface is configured to be arranged at any angle relative to the second cooking surface with the grill plate at any height relative to the tray.

### CROSS-REFERENCE TO RELATED APPLICATIONS

This application claims priority to U.S. Provisional Application No. 63/265,906 filed on Dec. 22, 2021, and entitled “Modular Bake Tray Assembly with Removable Panini Press,” the entire contents of which is hereby expressly incorporated by reference herein.

### FIELD

The present application generally relates to a modular bake tray assembly with a removable panini press for use with a toaster oven device.

### BACKGROUND

Existing countertop cooking systems, such as toaster ovens, may be used to conveniently warm or cook food. Food is typically inserted into an opening of a toaster oven and can be arranged directly on the internal food support element (e.g., grates) or placed on an accessory tray. In most conventional cooking systems, heating elements are arranged underneath the internal food support element at a distance such that the food resting on the internal support element does not directly contact the heating elements. Additionally, heating elements can be arranged above the internal food support element, but at a substantially large distance in order to create a gap to arrange food within the system on the internal food support element without contacting the upper heating elements. As a result, the toaster oven is only capable of cooking or warming food through convection heating means since the food is in little to no contact with heating elements, which would produce a Maillard reaction by concentrating the heat being produced by the heating elements.

It is therefore desirable to develop a tray assembly that can transform between various configurations based on the type of cooking operation to be performed.

### SUMMARY

Various cooking device assemblies are provided herein. In one embodiment, a cooking device assembly is provided and includes a cooking device having a housing with an opening, and a cooking compartment arranged within the housing and aligned with the opening. The assembly further includes a tray assembly configured to be arranged within the cooking compartment. The tray assembly includes a tray having a first cooking surface and a shield configured to sustainably cover the opening of the housing when the tray assembly is inserted into the cooking compartment, and an accessory removably mated to the tray. The accessory can include a grill plate having a second cooking surface. The accessory can further include a bracket having a first arm pivotally connected to a first side of the grill plate, and a second arm pivotally connected to a second side of the grill plate such that the first cooking surface is configured to be arranged at any angle relative to the second cooking surface with the grill plate at any height relative to the tray. In one embodiment, the accessory can be pivotally connected to the tray.

The grill plate and tray can have a variety of configurations. In one embodiment, the grill plate can include ribs arranged on the cooking surface. In other aspects, the tray can include a first handle extending from the tray.

The accessory can have a variety of configurations. For example, in some embodiment, the accessory can also include a second handle extending from the bracket. In other embodiments, the first handle can be configured to removably connect to the second handle. In certain embodiments, the second handle can include a clip configured to removably secure to the first handle. In some embodiments, the clip can include flexible opposed arms configured to partially encompass the first handle. In other embodiments, a channel can be arranged along a top edge of the shield. In certain embodiments, a portion of the bracket is positioned within the channel.

In another embodiment, a cooking tray assembly configured to be arranged within a cooking compartment of a cooking device is provided. The cooking tray assembly can include a tray having a first cooking surface and a shield configured to sustainably cover the opening of a housing when the tray assembly is inserted into a cooking compartment, and an accessory removably mated to the tray. The accessory can include a grill plate having a second cooking surface, and a bracket having a first arm pivotally connected to a first side of the grill plate and a second arm pivotally connected to a second side of the grill plate such that the first cooking surface is configured to be arranged at any angle relative to the second cooking surface with the grill plate at any height relative to the tray.

The grill plate and tray can have a variety of configurations. In one embodiment, the grill plate can include ribs arranged on the cooking surface. In other aspects, the tray can include a first handle extending from the tray.

The accessory can have a variety of configurations. For example, in some embodiment, the accessory can also include a second handle extending from the bracket. In other embodiments, the first handle can be configured to removably connect to the second handle. In certain embodiments, the second handle can include a clip configured to removably secure to the first handle. In some embodiments, the clip can include flexible opposed arms configured to partially encompass the first handle. In other embodiments, a channel can be arranged along a top edge of the shield. In certain embodiments, a portion of the bracket is positioned within the channel.

### BRIEF DESCRIPTION OF THE DRAWINGS

These and other features will be more readily understood from the following detailed description taken in conjunction with the accompanying drawings, in which:

FIG. 1 is a perspective view of a tray assembly according to one embodiment;

FIG. 2 is a side perspective view of the tray assembly of FIG. 1;

FIG. 3 is a perspective view of the tray assembly of FIG. 1 with a modular accessory removed from the tray;

FIG. 4 is a side perspective view of the tray assembly of FIG. 1 in a loading position;

FIG. 5 is a perspective view of the tray assembly of FIG. 1 in a fully open position;

FIG. 6 is a side perspective view of the tray assembly of FIG. 1 at a first height with food arranged therein;

FIG. 7 is a side perspective view of the tray assembly of FIG. 1 at a second height with food arranged therein;

FIG. 8 is a perspective view of the tray assembly of FIG. 1 arranged within a cooking device;

FIG. 9 is a top view of another embodiment of a tray assembly;

FIG. 10 is a side view of the tray assembly of FIG. 9;

FIG. 11 is a back view of the tray assembly of FIG. 9

FIG. 12 is a back perspective view of the tray assembly of FIG. 9 with the modular accessory removed from the tray;

FIG. 13 is a back perspective view of the tray assembly of FIG. 9 in a loading position;

FIG. 14 is a perspective view of the tray assembly of FIG. 9 in a cooking position;

FIG. 15 is a side view of the tray assembly of FIG. 13; and

FIG. 16 is a cross-sectional side view of the tray assembly of FIG. 13.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In general, a tray assembly 100 suitable for use with a cooking system, such as a toaster oven, is provided. Conventional toaster ovens use convection heating to warm or cook food, which does not concentrate heat energy in order to achieve a distinct Maillard reaction on food (e.g., browning). Other conventional devices, such as panini presses, which include heating elements embedded in heated plates which contact the food can achieve a sufficient Maillard reaction in food. However, these are two separate devices. By having the capability to have both a convection heating device, along with an optional conduction heating device, both forms of heat transfer can be achieved by a single cooking device having a similar envelope to only a toaster oven. This can increase counter top and storage space, since only once device is needed. Additionally, the heating elements of the disclosed cooking device do not need to be altered in order to use the conduction heating attachment, which simulates the use of a panini press.

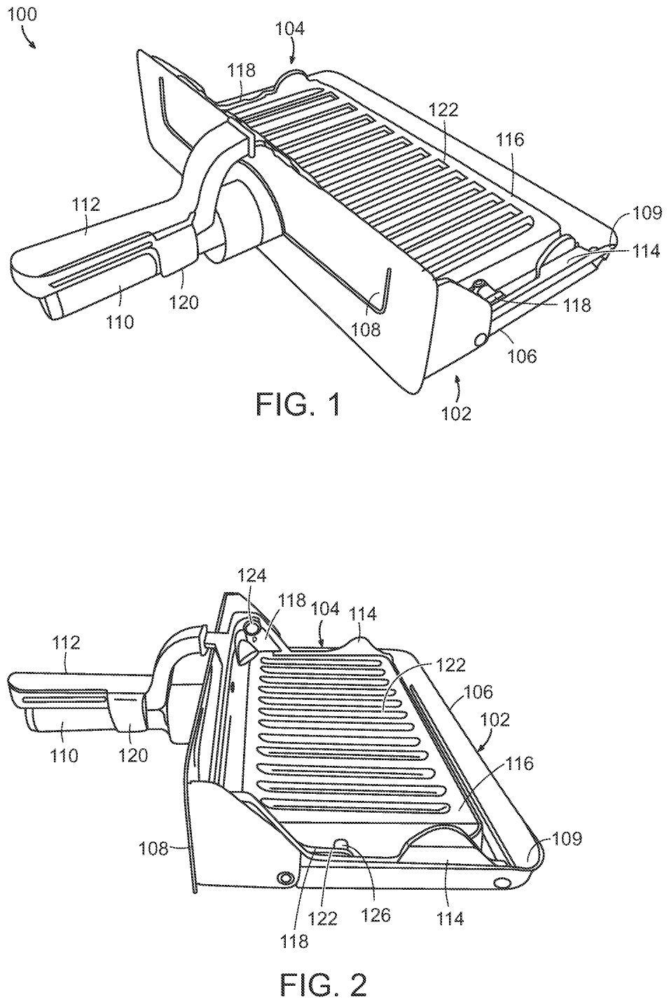

In an exemplary embodiment, shown in FIGS. 1-8, the tray assembly 100 generally includes a tray 102 and a removable accessory 104. In a first configuration, the removable accessory 104 can be detached and the tray 102 can be used in a conventional oven to warm or cook food on a surface of the tray using convection heating. In a second configuration, the removable accessory 104 can be attached to the tray 102 to allow food disposed there between to be warmed or cooked using conduction heating. The removable accessory 104 thus allows the tray assembly 100 to be used in a conventional oven without the need for a separate appliance. In the illustrated embodiment, the removable accessory 104 is a panini press, however it should be understood that a different form of removable accessory is within the scope of the disclosure.

While the tray 102 can have a variety of configurations, in the illustrated embodiment the tray includes a generally flat base 106, a lip 109, a shield 108 arranged sustainably perpendicular to the base 106, and a handle 110 extending from the shield 108. In one embodiment, the tray 102 is substantially rectangular in shape and can be formed from a thin layer of sheet metal or similar material suitable for cooking. The lip 109 can extend around the outer edge of the base 106 at an angle generally perpendicular to the base 106. The lip can be integral with the base 106 such that the lip 109 is formed from a rolled edge portion of the base 106 to form a curved internal surface along the edges of the base 106. In such embodiments, the lip 109 may, but need not, define a grip point for a user to grasp and manipulate the tray. In use, the lip 109 forms a shallow internal volume within the tray 102 for catching various fluids or food particulates that can be released by food during a cooking process. In other embodiments, a tray having any suitable configuration, such as a tray including only a generally flat base and no lip, is also within the scope of the disclosure.

The shield 108 can be arranged along a front edge of the tray 102 and can be integral with the lip 109 or mated to the lip 109. In other embodiments, the lip 109 can be eliminated along the front edge and the shield 108 can function as a lip. The shield 108 can have height that is configured to substantially or partially block the opening of a cooking device when the tray 102 is inserted within the cooking compartment of the cooking device, allowing the shield 108 to act as a door to the cooking device, as described in more detail below. The shield 108 also includes a channel 111 formed in the top edge of the shield, which allows the bracket 114 to pass over the top edge of the shield 108 and slot into the channel 111. With the bracket 114 arranged within the channel 111, the shield 108 and the bracket 114 can fully block the opening of a cooking device, with a top surface of the bracket 114 flush with the top edge of the shield 108.

As shown in the figures, the shield 108 has a height that is greater than a height of the lip such that the shield extends a distance above the tray. In certain exemplary embodiments, the shield is 2, 3, 4, 5, 6, or more times greater than a height of the lip. Additionally, in some embodiments, the shield is 2, 3, 4, 5, 6, or more times thicker than the thickness of the tray 102, and can include insulating material arranged on or within the shield 108.

As indicated above, the handle 110 can be coupled to and can extend from the front of shield. In some embodiments, the handle can directly connect to the base 106 or lip 108, and the shield 108 may be an optional attachment. The handle 110 can have any configuration that facilitates grasping by a user. In the illustrated embodiment, the handle has a shape that is complementary to a shape of a handle on the removable accessory, as will be discussed in detail below. As shown, the handle has a generally elongate cylindrical configuration.

As indicated above, the accessory 104 is configured to removably mate to the tray 102 to allow the accessory 104 and tray 102 to function as a panini press for cooking food there between. The accessory 104 can include a grill plate 116, a bracket 114 with pivoting arms 118, and a handle 112.

The grill plate 116 can have a variety of configurations, but in generally it can be configured to be arranged on and aligned with the tray 102 such that it extends generally parallel to the tray. In the illustrated embodiment, the grill plate 116 has a generally rectangular configuration with ribs 122 arranged on an upper facing surface thereof. The ribs 122 are arranged on the cooking surface 132 of the grill plate 116 in order to produce a Maillard reaction in the food items placed on the tray 102. In some embodiments, the grill plate 116 can have a smooth cooking surface instead of ribs 122. Additionally, in some embodiments, the grill plate can be oriented such that the connections to the pivoting arms and above or below the cooking surface 132.

The bracket 114 is coupled to the grill plate 116 and aids in positioning the grill plate 116 relative to the tray 102. In the illustrated embodiment, the bracket 114 is substantially U-shaped and has a back portion 114a that extends along one side of the grill plate 116, and two parallel arms 114b, 114c which extend parallel to one another on opposite sides of the grill plate 116, perpendicular to the back portion 114a. The bracket 114 can be formed from a singular structure that is bent to create the back portion 114a and the arms 114b, 114c, or it can be formed from multiple components mated to one another. The back portion 114a can include a downward slope in order to allow the handle 112 to reach over the shield 108, while also arranging the parallel arms 114b, 114c on the tray 102 such that the grill plate 116 contacts the cooking surface of the tray 102 when no food is arranged on the tray 102. In particular, the center of the back portion 114a can be positioned at a height that is greater than a height of the left and right ends of the back portion 114a.

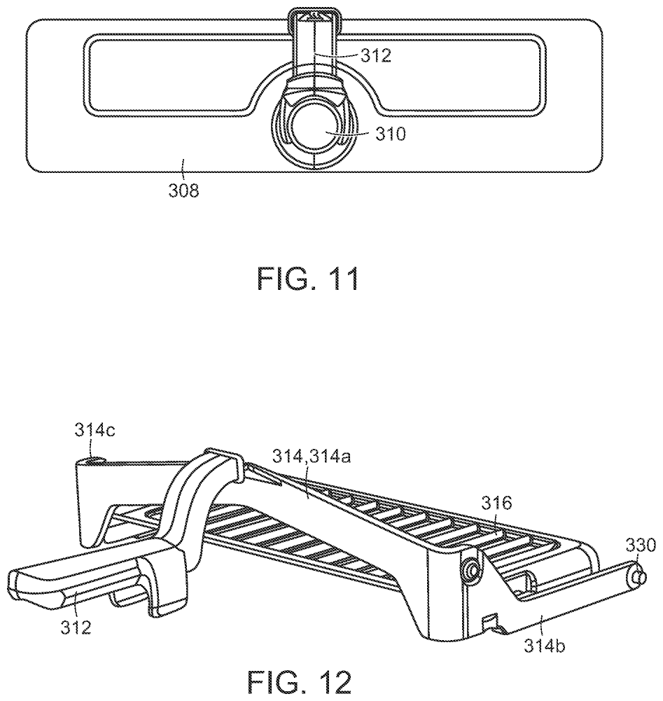

The bracket 114 can be coupled to the grill plate 116 on the accessory by a pair of pivoting arms 118 extending between the bracket 114 and the grill plate 116, as best shown in FIGS. 10-12. In the illustrated embodiment, the pivoting arms 118 have a flat elongate plate-like configuration with a straight portion and an angled portion. In particular, each arm 118 has a first elongate straight portion and a second elongate angled portion that extend at an angle greater than 90° relative to one another such that one of the portions extends parallel to the cooking surface of the tray 102 when no food is arranged on the tray 102. Each arm 118 has a through-bore at each end thereof for creating a pivoting connection. This allows a first end of each arm 118 to be mated at a first pivot point 124 to the bracket 114 and a second end of each arm 118 to be mated at a second pivot point 126 to the grill plate 116, thereby coupling the bracket 114 to the grill plate 116. In some embodiments, torsional springs (not shown) can be arranged between the bracket 114, grill plate 116, and arms 118 in order to bias the grill plate and arms 118 towards a resting position. The resting position is when the grill plate 116 is resting on the tray 102. When food is placed on the tray 102, the torsional springs will place a rotational force on the arms 118, which compresses the food between the grill plate 116 and the tray 102.

When mated, the first elongate straight portion of the pivoting arms 118 can extend parallel to the arms of the bracket 114 and to the grill plate 116, and the second elongate angled portion extends at an angle to connect to grill plate 116. The pivoting arms 118 can connect to the grill plate 116 at substantially a mid-portion of each side of the grill plate 116. As described in greater detail below, the pivoting arms 118 are pivotally secured to the bracket 114 and the grill plate 116, which allows the grill plate 116 to remain perpendicular to the tray 102 at any height.

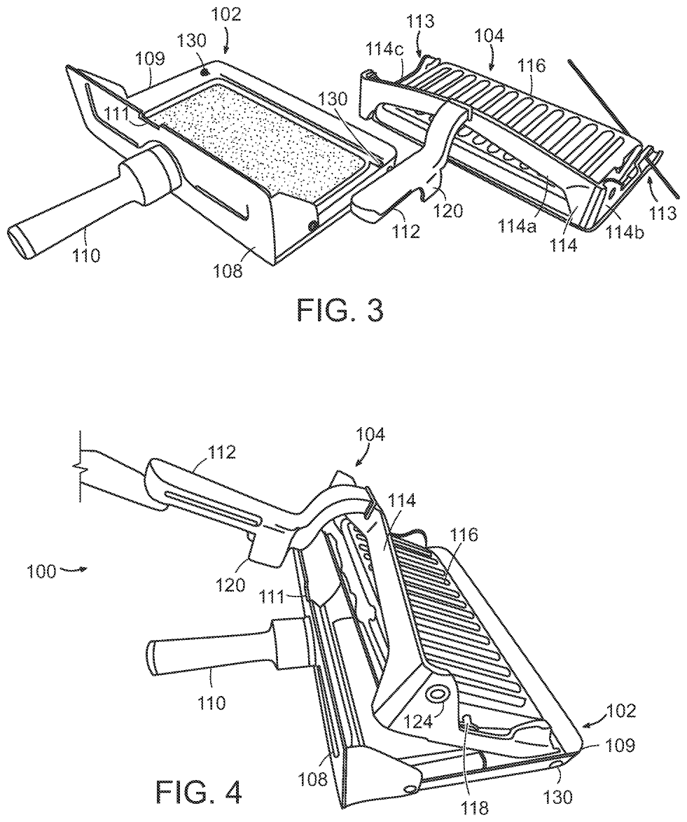

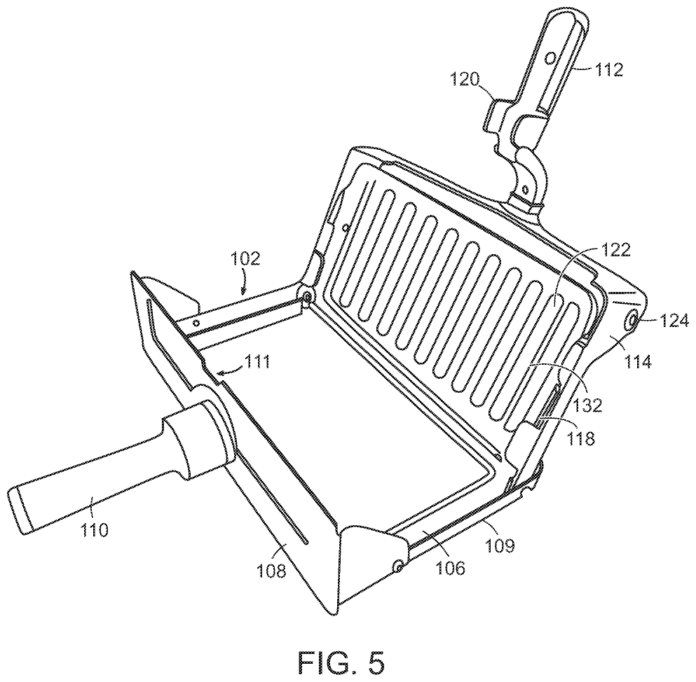

In order to facilitate connection between the accessory 104 and the tray 102, the tray 102 can further include projections 130 arranged on opposite sides thereof and in the lip 109, as best shown in FIG. 3. The illustrated projections 130 are in the form of pins configured to be removably rotatably disposed within apertures 113 in the bracket 114 to allow the accessory 104 to pivot relative to the tray 102, as shown in FIGS. 4-5. In some embodiments, the projections 130 are arranged such that accessory 104 can pivot relative to tray 102, but cannot be removed from tray 102 unless the accessory 104 is positioned at a certain angle relative to the tray 102. In such embodiments, the projections 130 can include an enlarged head that is keyed, and a cylindrical shaft or pint in order to allow rotation. The enlarged head can include an alignment feature, such as a flat portion along the exterior surface of the cylinder, which does not hinder rotation but does prevent unintended removal of the projections 130. In such embodiments, the apertures in the accessory 104 can include a notch, which is complimentarily-shaped with the enlarged head of the projections 130 and includes an alignment feature complementary to the alignment feature of the projections 130. With both alignment features aligned at a specific angle, the projections 130 can slide into the apertures 113 of the bracket 114. This allows the projections 130 to slide into the apertures 113 to then pivot to prevent removal of the projections unless the alignment feature of the notch is aligned with the alignment feature of the projections 130.

As further shown, the handle 112 on the accessory can be mated to a mid-portion of the bracket 114 and can extend forward of the bracket 114. The handle 112 can include an arch-shaped portion extending downward from the bracket, and a grasping portion having a shape that is complementary to the shape of the handle 110 on the tray 102. In the illustrated embodiment, the handle has a generally elongate cylindrical configuration, however it is hollow to receive a portion of the handle 110 on the tray therein. The handle 112 of the accessory 104 can also include a clip 120 arranged on the bottom of the handle that is complementary to a section of the handle 110 of the tray 102 in order to connect the accessory 104 to the tray 102. In the illustrated embodiment, the clip 120 includes opposed arms that are configured to engage opposed sides of the handle 110 on the tray 102 with a friction fit. The opposed arms of the clip 120 can be flexible, and be deformed in order to selectively position around the diameter of the handle 110, securing the accessory 104 to the tray 102, while also allowing for easy removal of the accessory 104 from the tray 102. However, other forms of removable connections between the tray 102 and the accessory 104 should be considered within the scope of this disclosure.

In use, the accessory 104 can be mated to the tray 102 by securing the projections 130 to the bracket 114. When the accessory is mated to the tray, the bracket 114 aligns the grill plate 116 with the tray 102. The handle 112 extends over the shield 108 and connects to the handle 110 on the tray, anchoring the bracket 114 to the tray 102 through the handles 110, 112.

Referring to FIGS. 5-7, with the accessory 104 pivotally connected to the tray 102 via the projections 130, the accessory 104 can be moved to an open position relative to the tray 102 in order to place food items on the tray 102. With food items arranged on the tray, the accessory 104 can be pivoted closed in order to secure the handle 112 to the handle 110 via the clip 120.

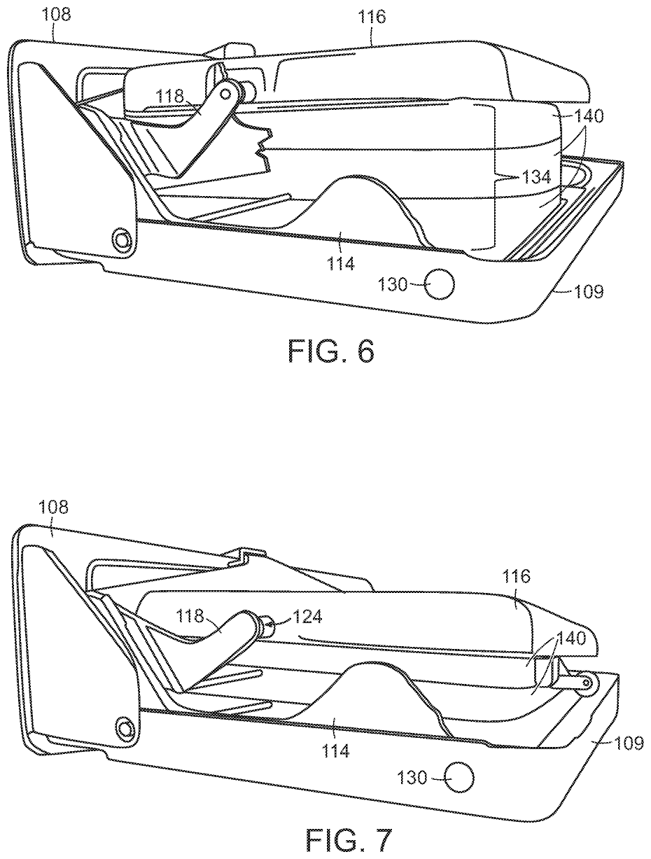

As stated above, the pivoting arms 118 are configured such that the grill plate 116 can remain parallel to the tray 102 regardless of the height of food items placed on the tray 102 since the grill plate 116 can pivot relative to the tray 102. Additionally, depending on the food placed between the tray 102 and the grill plate 116, the grill plate can be arranged at any angle relative to the tray 102 to ensure proper contact with the food in the event the top surface of the food includes an angled top surface. As illustrated in FIGS. 6-7, the pivoting arms 118 rotate at both the pivot points 124 on the bracket 114 and the pivot points 126 of the grill plate 116 in order to keep the grill plate 116 level with the tray 102. As shown in FIG. 5, the accessory 104 can be rotated away from the tray 102 by disconnecting the clip 120 from the handle 110. With the accessory 104 and grill plate 116 in the raised positon, food can be arranged on the tray 102. As the accessory 104 and grill plate are rotated back down such that the handles 110, 112 contact one another, a gap 134 is formed between the tray 102 and the grill plate 116. In normal operation, the gap 134 is formed when the grill plate 116 contacts food items arranged on the tray 102. The pivoting arms 118 begin to pivot due to contact with the food items by the grill plate 116, and the arms keep the grill plate 116 at the same height while the accessory 104 is lowered back down to connect the handles 110, 112 to each other.

As illustrated in FIGS. 6-7 the grill plate 116 can remain generally parallel to the tray 102 regardless of the height of the food items arranged on the tray 102. FIG. 6 illustrates the tray assembly 100 with three food items 140 stacked on top of each other. This places the grill plate 116 at a first height, while remaining parallel to the tray 102. Additionally, FIG. 7 illustrates the tray assembly 100 with only two food items 140, which places the grill plate 166 at a second height, lower than the first height. As shown in the figures, the grill plate remains parallel at both the first and second height, allowing the tray assembly 100 to be used with multiple types and sizes of food items while achieving the desired Maillard reaction by the grill plate 116 and ribs 122. Additionally, the grill plate 116 can be arranged at any angle relative to the tray 102 to ensure the grill plate 116 has proper contact with any food items 140 arranged between the tray 102 and the grill plate 116.

Various removable accessories or inserts 104 may be suitable for use with the tray 102. In an exemplary embodiment, the accessory 104 is a foldable grill or press. Examples of such an accessory 104 include, but are not limited to, a panini grill, a flat griddle, a waffle press, and a toaster press. Each of these tray assemblies 100 may include a tray and an accessory pivotally coupled to one another between a first position and a second position. In the illustrated, non-limiting embodiment, the housing portions are substantially identical and are movable about an axis to “fold” into a closed position where a cavity is formed between the housing portions. Such a foldable grill or press accessory is receivable within the cooking compartment when in the closed position. However, embodiments where only a portion of a foldable press accessory, such as a single housing portion for example, is used as an accessory are also within the scope of the disclosure. Further, other accessories having two or move portions that are pivotally or rotatable coupled to one another or movement between two or more positions are contemplated herein.

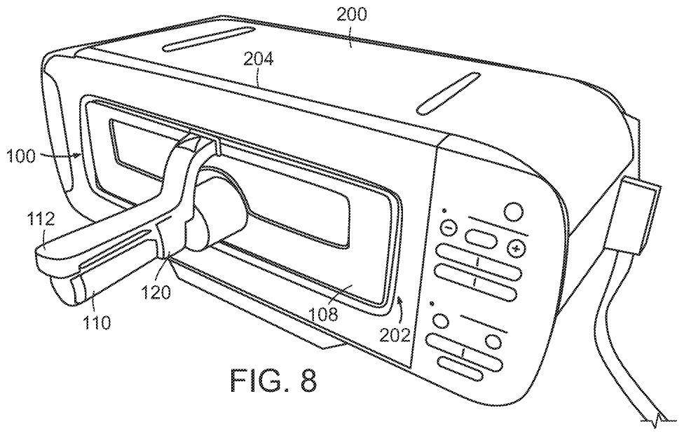

As illustrated in FIGS. 8, one or more tray assemblies 100 configured to support a food item may be installed within the cooking compartment of a cooking device 200. In one embodiment, as shown in FIG. 8, the tray assembly 100 may be stowed within a cooking compartment 202. When positioned within the cooking compartment 202, a portion of the tray assembly 100 may, but need not be, flush with an exterior surface of the housing 204. Each of the one or more tray assemblies 100 suitable for use with the cooking device 200 may be supported within the cooking compartment 202 directly or indirectly by food support elements within the cooking compartment 202.

The cooking compartment 202 can be in fluid communication with the ambient atmosphere surrounding the cooking device 200 via the opening in the housing 204. Accordingly when using the cooking device 200, the cooking compartment 202 may be unevenly heated as a result of heat escaping through the opening. To minimize this heat loss through the opening, the shield 108 can be configured to close or cover at least a portion of the opening. The shield 108 may be a component separate from and connectable to the tray assembly 100 or the housing 204 to close or cover at least a portion of the opening. In another embodiment, the shield 108 may be formed as part of the tray assembly 100 and is configured to close all or a majority of the opening when the tray assembly 100 is positioned within the cooking compartment 202. Accordingly, the shield 108 may be formed from the same material as an accessory or may be formed from a different material as the accessory. In an embodiment, at least a portion of the shield is formed from a transparent material, such as glass.

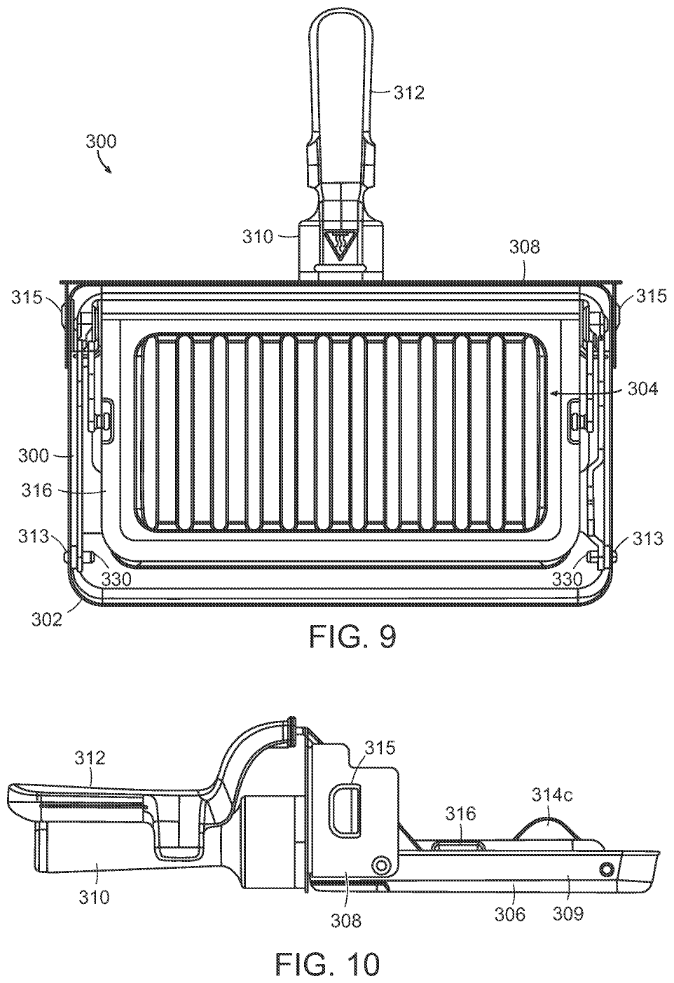

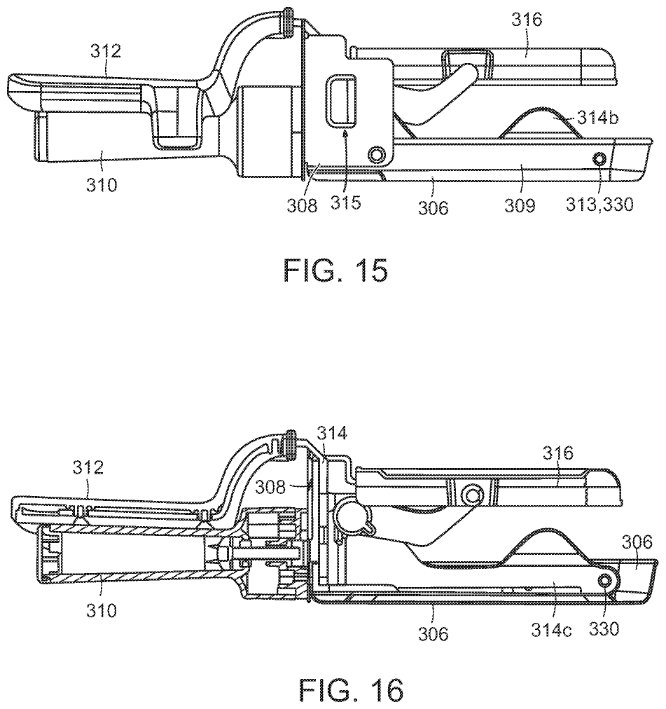

In another exemplary embodiment, shown in FIGS. 9-16, a tray assembly 300 generally includes a tray 302 and a removable accessory 304. The tray assembly 300 is substantially similar to the tray assembly 100 illustrated in FIGS. 1-8. However, the tray 302 and the accessory 304 are mated in a different manner, as explained below.

Similar to tray 102, tray 302 includes similar components such as a generally flat base 306, a shield 308, a lip 309, and a handle 310 extending from the shield 308. Additionally, and similar to accessory 104, accessory 304 is configured to removably mate to the tray 302 to allow the accessory 304 and tray 302 to function as a panini press for cooking food there between. The accessory 304 can include a grill plate 316, a bracket 314 with pivoting arms 318, and a handle 312.

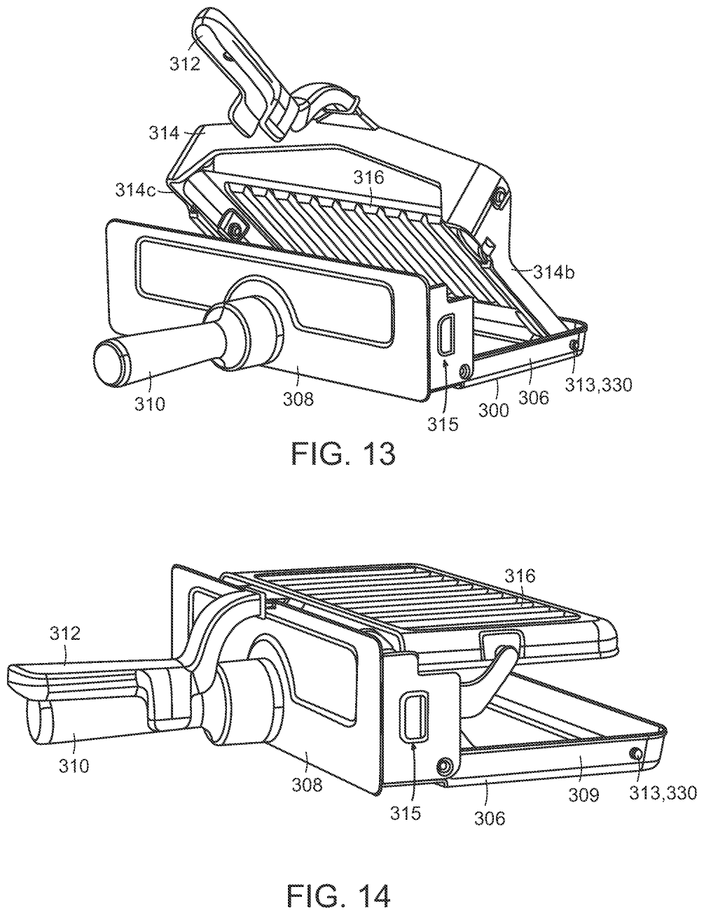

In order to facilitate connection between the accessory 304 and the tray 302, in this embodiment the bracket 314 includes projections 330 arranged on two parallel arms 314b, 314c which extend parallel to one another on opposite sides of a back portion 314a of the bracket 314, as best shown in FIG. 12. Similar to projections 130, the illustrated projections 330 are in the form of pins configured to be removably rotatably disposed within apertures 313 in the lip 309 of the tray 302 to allow the accessory 304 to pivot relative to the tray 302, as shown in FIG. 13. In some embodiments, even though the projections 330 are arranged on the bracket 314, the projections 330 can include features, such as a keyed head or notch to prevent unintentional removal of the accessory 304 from the tray 302. Additionally, in some embodiments, the accessory 304 can be removed from the tray 302 by removing the projections 330 from the apertures 313 by either deforming the parallel arms 314b, 314c, or by sliding the projections 330 inward and out of the apertures 313. The shield 308 also includes projections 315, which extend outward from the shield 308. The projections 330 are configured to correspond to indents (not shown) arranged on the inner wall of a cooking device in order to secure the tray assembly 300. The projections 330 can be integral within the shield 308, or positioned on the shield 308.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

What is claimed is:

1. A cooking device assembly, comprising:
a cooking device, comprising:
a housing having an opening; and
a cooking compartment arranged within the housing and aligned with the opening; and
a tray assembly configured to be arranged within the cooking compartment, the tray assembly comprising:
a tray having a first cooking surface and a rear edge;
a shield extending upward from the cooking surface and adjacent the rear edge of the tray, wherein the shield is configured to cover the opening of the housing when the tray assembly is inserted into the cooking compartment; and
an accessory removably mated to the tray, the accessory including a grill plate having a second cooking surface, and a bracket having a first arm pivotally connected to a first side of the grill plate and a second arm pivotally connected to a second side of the grill plate such that the first cooking surface is configured to be arranged at any angle relative to the second cooking surface.

2. The cooking device assembly of claim 1, wherein the bracket is pivotally connected to the tray.

3. The cooking device assembly of claim 1, wherein the grill plate further includes ribs arranged on the cooking surface.

4. The cooking device assembly of claim 1, wherein the tray further includes a first handle extending from the shield.

5. The cooking device assembly of claim 4, wherein the accessory further includes a second handle extending from the bracket.

6. The cooking device assembly of claim 5, wherein the first handle is configured to removably connect to the second handle.

7. The cooking device assembly of claim 5, wherein the second handle includes a clip configured to removably secure to the first handle.

8. The cooking tray assembly of claim 7, wherein the clip includes flexible opposed arms configured to partially encompass the first handle.

9. The cooking tray assembly of claim 1, wherein a channel is arranged along a top edge of the shield.

10. The cooking tray assembly of claim 9, wherein a portion of the bracket is positioned within the channel.

11. A cooking tray assembly configured to be arranged within a cooking compartment of a cooking device, the cooking tray assembly comprising:
a tray having a first cooking surface and a rear edge;
a shield extending upward from the cooking surface and adjacent the rear edge of the tray, wherein the shield is configured to cover the opening of a housing when the tray assembly is inserted into a cooking compartment; and
an accessory removably mated to the tray, the accessory including a grill plate having a second cooking surface, and a bracket having a first arm pivotally connected to a first side of the grill plate, and a second arm pivotally connected to a second side of the grill plate such that the first cooking surface is configured to be arranged at any angle relative to the second cooking surface.

12. The cooking tray assembly of claim 11, wherein the bracket is pivotally connected to the tray.

13. The cooking tray assembly of claim 11, wherein the grill plate further includes ribs arranged on the cooking surface.

14. The cooking tray assembly of claim 11, wherein the tray further includes a first handle extending from the shield.

15. The cooking tray assembly of claim 14, wherein the accessory further includes a second handle extending from the bracket.

16. The cooking tray assembly of claim 15, wherein the first handle is configured to removably connect to the second handle.

17. The cooking tray assembly of claim 15, wherein the second handle includes a clip configured to removably secure to the first handle.

18. The cooking tray assembly of claim 17, wherein the clip includes flexible opposed arms configured to partially encompass the first handle.

19. The cooking tray assembly of claim 11, wherein a channel is arranged along a top edge of the shield.

20. The cooking tray assembly of claim 19, wherein a portion of the bracket is positioned within the channel.
